(19) United States
(12) Patent Application Publication
(10) Pub. No.: US 2026/0199908 A1
(43) Pub. Date: Jul. 16, 2026

(54) FLOTATION METHOD FOR RECOVERY OF COPPER OXIDE ORE WITH FULL-SIZE FRACTIONS

(71) Applicant: Kunming University of Science and Technology, Kunming City (CN)

(72) Inventors: Qicheng FENG, Kunming City (CN); Yanyu TANG, Kunming City (CN); Shuming WEN, Kunming City (CN); Qian ZHANG, Kunming City (CN); Han WANG, Kunming City (CN); Guang HAN, Kunming City (CN)

(21) Appl. No.: 19/401,015

(22) Filed: Nov. 25, 2025

(30) Foreign Application Priority Data
Jan. 10, 2025 (CN) 202510044132.2

(51) Int. Cl. B03D 1/08; B03D 1/02

(52) U.S. Cl. CPC B03D 1/085; B03D 1/025; B03D 2201/02; B03D 2201/04; B03D 2203/04

(57) ABSTRACT

Provided is a flotation method for full-particle size recovery of a copper oxide ore. In this method, a composite grinding aid is used to reduce the surface hardness and compressive strength of copper oxide ore particles and mitigate the agglomeration of ore particles and the adhesion of ore particles to a mill liner and a grinding medium. A composite regulator is used to regulate the pulp environment and mineral surface properties. A composite collector is used to enable the selective enhancement of surface hydrophobicity for copper oxide minerals across different particle sizes. A cleaner scavenger stage is added to prevent a copper-containing middling from circulating and accumulating repeatedly at rougher and cleaner stages.

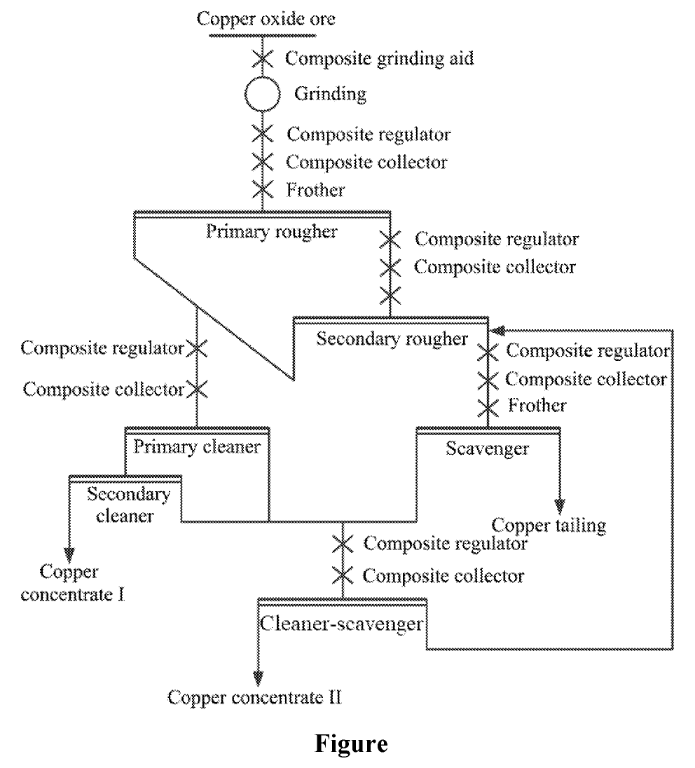

### CROSS REFERENCE TO RELATED APPLICATION

This application claims the benefit of and priority to Chinese Patent Application No. 202510044132.2, filed January 10, 2025, which is hereby incorporated by reference herein in its entirety.

### TECHNICAL FIELD

The present disclosure relates to a flotation method for recovery of copper oxide ore with full-size fractions, and belongs to the technical field of mineral processing.

### BACKGROUND

Flotation is the major method for separating and concentrating copper oxide minerals. However, due to the strong surface hydrophilicity of copper oxide minerals, the high soluble salt content in copper oxide ore, and the complex intergrowth relationship of copper oxide minerals with gangue minerals, the conventional beneficiation method struggles to achieve the efficient recovery of copper oxide minerals.

Particle size significantly impacts recovery indices for copper oxide ore during flotation. Thus, the control of a grinding process for copper oxide ore is critically important. During a grinding process of copper oxide ore, with the refinement of ore particles, the surface area of ore particles gradually increases, the surface of ore particles is charged due to bond breakage, and ore particles adhere to each other and agglomerate, resulting in declined grinding efficiency. Thus, a specified amount of a grinding aid is added during a grinding process, which could not only prevent the agglomeration of ore particles, but also improve the fluidity of an ore during grinding. The addition of a grinding aid can enhance the grinding efficiency, shorten the grinding time, reduce the energy consumption of grinding, optimize the particle size distribution of an ore, and mitigate the degree of ore sliming. Further, due to the complex properties of copper oxide ore, it is difficult to effectively recover copper minerals across all size fractions with the conventional flotation reagents. Particularly for fine-grained copper oxide minerals, high-efficiency regulators and collectors are often required to selectively regulate the pulp environment and the mineral surface properties, thereby achieving the effective separation and concentration of copper oxide minerals from gangue minerals.

However, the existing grinding aids, regulators, and collectors demonstrate limited applicability in the flotation for copper oxide ore, and lead to unsatisfactory flotation recovery effects for copper oxide minerals, which severely affects the efficient utilization of copper ore resources and the economic benefits of enterprises.

Therefore, there is an urgent need to develop a beneficiation method that integrates grinding, pulp conditioning, and collection to achieve the recovery of refractory copper oxide ore with full-size fractions.

### SUMMARY

In view of the fact that the efficient utilization of copper ore resources is seriously compromised due to large beneficiability differences among and difficult simultaneous recovery of copper oxide minerals across different particle sizes, the present disclosure proposes a flotation method for recovery of copper oxide ore with full-size fractions. In this method, a composite grinding aid is used to improve the grindability, dispersion behavior, and particle size distribution of ores, a composite regulator is used to achieve the selective activation of copper oxide minerals and the selective depression of gangue minerals in the ores, and a composite collector is used to enhance the mineral-loading capacity of a froth and the beneficiability for the ores. Moreover, a cleaner scavenger stage is added to prevent a copper-containing middling from circulating and accumulating repeatedly at rougher and cleaner stages, thereby effectively eliminating the adverse impacts on flotation indices.

A flotation method for recovery of copper oxide ore with full-size fractions is provided, including the following steps:

(1) mixing the copper oxide ore with a composite grinding aid evenly, subjecting a resulting mixture to grinding until a copper oxide mineral grains are dissociated, adding water, and conditioning until a mass percentage concentration of an obtained pulp reaches 28% to 38%, to obtain a copper oxide ore pulp;

(2) adding a composite regulator, a composite collector, and a frother sequentially to the copper oxide ore pulp obtained in step (1), and conducting a primary rougher to obtain a primary rougher concentrate and a primary rougher tailing;

(3) adding the composite regulator, the composite collector, and the frother sequentially to the primary rougher tailing obtained in step (2), and conducting a secondary rougher to obtain a secondary rougher concentrate and a secondary rougher tailing;

(4) adding the composite regulator, the composite collector, and the frother sequentially to the secondary rougher tailing obtained in step (3), and conducting scavenger to obtain a scavenger concentrate and a scavenger tailing;

(5) combining the primary rougher concentrate obtained in step (2) with the secondary rougher concentrate obtained in step (3) to obtain a mixture, adding the composite regulator and the composite collector to the mixture, and conducting a primary cleaner to obtain a primary cleaner concentrate and a primary cleaner tailing;

(6) conducting a secondary cleaner on the primary cleaner concentrate obtained in step (5) to produce a copper concentrate I and a secondary cleaner tailing;

(7) combining the scavenger concentrate obtained in step (4), the primary cleaner tailing obtained in step (5), and the secondary cleaner tailing obtained in step (6) to obtain a mixed middling; and adding the composite regulator and the composite collector sequentially to the mixed middling, and conducting cleaner-scavenger to obtain a copper concentrate II and a cleaner scavenger tailing, wherein the cleaner scavenger tailing is returned to the scavenger; and

(8) combining the copper concentrate I obtained in step (6) with the copper concentrate II obtained in step (7) to obtain a copper concentrate, and taking the scavenger tailing obtained in step (4) as a copper tailing,

where the composite grinding aid is a mixture of triethanolamine, diethylene glycol, and polyether amine; the composite regulator is a mixture of sodium sulfide, ammonium phosphate, carboxymethyl cellulose, and a phosphino-carboxylic acid copolymer; and the composite collector is a mixture of sodium isoamyl xanthate, sodium O,O-diisopropyl dithiophosphate, and octyl hydroxamic acid.

In some embodiments, in step (1), a mass content of copper in the copper oxide ore is in a range of 0.7% to 1.9%.

In some embodiments, in terms of each ton of the copper oxide ore, 260 g to 540 g of the composite grinding aid is added in step (1).

In some embodiments, in terms of each ton of the copper oxide ore, 1,800 g to 2,600 g of the composite regulator, 520 g to 840 g of the composite collector, and 40 g to 80 g of the frother are added for conducting the primary rougher in step (2).

In some embodiments, in terms of each ton of the copper oxide ore, 900 g to 1,300 g of the composite regulator, 260 g to 420 g of the composite collector, and 20 g to 40 g of the frother are added for conducting the secondary rougher in step (3).

In some embodiments, in terms of each ton of the copper oxide ore, 450 g to 650 g of the composite regulator, 130 g to 210 g of the composite collector, and 10 g to 20 g of the frother are added for conducting the scavenger in step (4).

In some embodiments, in terms of each ton of the copper oxide ore, 225 g to 325 g of the composite regulator and 65 g to 105 g of the composite collector are added for conducting the primary cleaner in step (5).

In some embodiments, in terms of each ton of the copper oxide ore, 600 g to 860 g of the composite regulator and 100 g to 160 g of the composite collector are added for conducting the cleaner-scavenger in step (7).

In some embodiments, taking a mass fraction of the composite grinding aid as 100%, the triethanolamine accounts for 50% to 60%, the diethylene glycol accounts for 30% to 40%, and the polyether amine accounts for 5% to 15%;

taking a mass fraction of the composite regulator as 100%, the sodium sulfide accounts for 45% to 55%, the ammonium phosphate accounts for 20% to 30%, the carboxymethyl cellulose accounts for 10% to 20%, and the phosphino-carboxylic acid copolymer accounts for 5% to 15%; and

taking a mass fraction of the composite collector as 100%, the sodium isoamyl xanthate accounts for 40% to 60%, the sodium O,O-diisopropyl dithiophosphate accounts for 20% to 40%, and the octyl hydroxamic acid accounts for 10% to 30%.

In some embodiments, the frother is terpenic oil.

Some embodiments of the present disclosure exhibit the following beneficial effects:

(1) Through the integrated whole-process control of grinding, pulp conditioning, collection, and middling circulation, the present disclosure gives full play to a synergistic effect of flotation reagents to selectively regulate the pulp environment and mineral surface properties. As a result, the present disclosure economically and efficiently addresses the problem that copper oxide minerals across different particle sizes in copper oxide ore demonstrate significant differences in beneficiability and can hardly be recovered simultaneously, and proposes a new approach for the efficient separation and concentration of refractory copper ore resources.

(2) In the ore grinding process of the present disclosure, the addition of the composite grinding aid could effectively reduce the surface energy of ore particles, decrease the surface hardness and compressive strength of copper oxide ore particles, mitigate the agglomeration of ore particles and the adhesion of ore particles to a mill liner and a grinding medium, and improve the grindability, dispersion behavior, and particle size distribution of copper oxide ore, thereby enhancing the grinding efficiency of copper oxide ore and preventing the severe ore sliming.

(3) The combined use of the composite regulator and the composite collector in the present disclosure not only achieves the selective activation of copper oxide minerals and the selective depression of gangue minerals in copper oxide ore, but also enables the selective enhancement of surface hydrophobicity for copper oxide minerals across different particle sizes. Consequently, the combined use of the composite regulator and the composite collector enhance the flotability difference between copper oxide minerals and gangue minerals, and improves the mineral-loading capacity of a froth and the beneficiability for copper oxide ore, thereby facilitating the recovery of refractory copper oxide ore with full-size fractions.

(4) During the flotation of copper oxide ore according to the present disclosure, a cleaner-scavenger stage is added to centralize the treatment of the middlings generated at cleaner and scavenger stages, such that these middlings are not returned to the rougher and cleaner stages. The addition of the cleaner-scavenger stage could avoid the repeated circulation and accumulation of copper-containing middlings and slimes at the rougher and cleaner stages, effectively eliminate the adverse impacts on flotation indices, and address the issues of bubble control and sliming depression during the flotation of copper oxide ore, thereby remarkably improving the utilization of copper ore resources.

### BRIEF DESCRIPTION OF THE DRAWINGS

Figure shows a flow chart of the method according to an embodiment of the present disclosure.

### DETAILED DESCRIPTION OF THE EMBODIMENTS

The present disclosure is further described in detail below in conjunction with specific embodiments, but the scope of the present disclosure is not limited thereto.

In the examples of the present disclosure, the composite grinding aid was a mixture of triethanolamine, diethylene glycol, and polyether amine, the composite regulator was a mixture of sodium sulfide, ammonium phosphate, carboxymethyl cellulose, and a phosphino-carboxylic acid copolymer, and the composite collector was a mixture of sodium isoamyl xanthate, sodium O,O-diisopropyl dithiophosphate, and octyl hydroxamic acid.

### Example 1

In this example, taking a mass fraction of the composite grinding aid as 100%, the triethanolamine accounted for 50%, the diethylene glycol accounted for 35%, and the polyether amine accounted for 15%. Taking a mass fraction of the composite regulator as 100%, the sodium sulfide accounted for 45%, the ammonium phosphate accounted for 25%, the carboxymethyl cellulose accounted for 20%, and the phosphino-carboxylic acid copolymer accounted for 10%. Taking a mass fraction of the composite collector as 100%, the sodium isoamyl xanthate accounted for 40%, the sodium O,O-diisopropyl dithiophosphate accounted for 40%, and the octyl hydroxamic acid accounted for 20%.

As shown in the Figure, a flotation method for recovery of copper oxide ore with full-size fractions was conducted by the following steps:

(1) The copper oxide ore was mixed with the composite grinding aid evenly, and a resulting mixture was added to a grinding mill and ground until copper oxide mineral grains are dissociated. Water was added thereto and conditioned until a mass percentage concentration of an obtained pulp reaches 28% to obtain a copper oxide ore pulp. In terms of each ton of the copper oxide ore, 260 g of the composite grinding aid was added in the grinding mill. A mass percentage content of copper in the copper oxide ore was 0.7%.

(2) The composite regulator, the composite collector, and the frother were added sequentially to the copper oxide ore pulp obtained in step (1). A primary rougher was conducted to obtain a primary rougher concentrate and a primary rougher tailing. In terms of each ton of the copper oxide ore,1,800 g of the composite regulator, 520 g of the composite collector, and 40 g of the frother were added for conducting the primary rougher.

(3) The composite regulator, the composite collector, and the frother were added sequentially to the primary rougher tailing obtained in step (2), and a secondary rougher was conducted to obtain a secondary rougher concentrate and a secondary rougher tailing. In terms of each ton of the copper oxide ore, 900 g of the composite regulator, 260 g of the composite collector, and 20 g of the frother were added for conducting the secondary rougher.

(4) The composite regulator, the composite collector, and the frother were added sequentially to the secondary rougher tailing obtained in step (3), and scavenger was conducted to obtain a scavenger concentrate and a scavenger tailing. In terms of each ton of the copper oxide ore, 450 g of the composite regulator, 130 g of the composite collector, and 10 g of the frother were added for conducting the scavenger.

(5) The primary rougher concentrate obtained in step (2) was combined with the secondary rougher concentrate obtained in step (3), and the composite regulator and the composite collector were added thereto. A primary cleaner was conducted to obtain a primary cleaner concentrate and a primary cleaner tailing. In terms of each ton of the copper oxide ore, 225 g of the composite regulator and 65 g of the composite collector were added for conducting the primary cleaner.

(6) The primary cleaner concentrate obtained in step (5) was subjected to a secondary cleaner to obtain a copper concentrate I and a secondary cleaner tailing.

(7) The scavenger concentrate obtained in step (4), the primary cleaner tailing obtained in step (5), and the secondary cleaner tailing obtained in step (6) were combined to obtain a mixed middling. The composite regulator and the composite collector were added sequentially to the mixed middling, and cleaner-scavenger was conducted to obtain a copper concentrate II and a cleaner scavenger tailing. The cleaner-scavenger tailing was returned to the scavenger. In terms of each ton of the copper oxide ore, 600 g of the composite regulator and 100 g of the composite collector were added for conducting the cleaner-scavenger.

(8) The copper concentrate I obtained in step (6) was combined with the copper concentrate II obtained in step (7) to obtain a copper concentrate. The scavenger tailing obtained in step (4) was taken as a copper tailing.

In this example, a copper recovery of the flotation was 81.8%.

### Example 2

In this example, taking a mass fraction of the composite grinding aid as 100%, the triethanolamine accounted for 55%, the diethylene glycol accounted for 40%, and the polyether amine accounted for 5%. Taking a mass fraction of the composite regulator as 100%, the sodium sulfide accounted for 50%, the ammonium phosphate accounted for 30%, the carboxymethyl cellulose accounted for 15%, and the phosphino-carboxylic acid copolymer accounted for 5%. Taking a mass fraction of the composite collector as 100%, the sodium isoamyl xanthate accounted for 50%, the sodium O,O-diisopropyl dithiophosphate accounted for 20%, and the octyl hydroxamic acid accounted for 30%.

As shown in the Figure, a flotation method for recovery of copper oxide ore with full-size fractions was conducted by the following steps:

(1) The copper oxide ore was mixed with the composite grinding aid evenly, and a resulting mixture was added to a grinding mill and ground until copper oxide mineral grains are dissociated. Water was added thereto and conditioned until a mass percentage concentration of an obtained pulp reaches 33% to obtain a copper oxide ore pulp. In terms of each ton of the copper oxide ore, 400 g of the composite grinding aid was added in the grinding mill. A mass percentage content of copper in the copper oxide ore was 1.3%.

(2) The composite regulator, the composite collector, and the frother were added sequentially to the copper oxide ore pulp obtained in step (1). A primary rougher was conducted to obtain a primary rougher concentrate and a primary rougher tailing. In terms of each ton of the copper oxide ore, 2,200 g of the composite regulator, 680 g of the composite collector, and 60 g of the frother were added for conducting the primary rougher.

(3) The composite regulator, the composite collector, and the frother were added sequentially to the primary rougher tailing obtained in step (2), and a secondary rougher was conducted to obtain a secondary rougher concentrate and a secondary rougher tailing. In terms of each ton of the copper oxide ore, 1,100 g of the composite regulator, 340 g of the composite collector, and 30 g of the frother were added for conducting the secondary rougher.

(4) The composite regulator, the composite collector, and the frother were added sequentially to the secondary rougher tailing obtained in step (3), and scavenger was conducted to obtain a scavenger concentrate and a scavenger tailing. In terms of each ton of the copper oxide ore, 550 g of the composite regulator, 170 g of the composite collector, and 15 g of the frother were added for conducting the scavenger.

(5) The primary rougher concentrate obtained in step (2) was combined with the secondary rougher concentrate obtained in step (3), and the composite regulator and the composite collector were added thereto. A primary cleaner was conducted to obtain a primary cleaner concentrate and a primary cleaner tailing. In terms of each ton of the copper oxide ore, 275 g of the composite regulator and 85 g of the composite collector were added for conducting the primary cleaner.

(6) The primary cleaner concentrate obtained in step (5) was subjected to a secondary cleaner to obtain a copper concentrate I and a secondary cleaner tailing.

(7) The scavenger concentrate obtained in step (4), the primary cleaner tailing obtained in step (5), and the secondary cleaner tailing obtained in step (6) were combined to obtain a mixed middling. The composite regulator and the composite collector were added sequentially to the mixed middling, and cleaner-scavenger was conducted to obtain a copper concentrate II and a cleaner scavenger tailing. The cleaner-scavenger tailing was returned to the scavenger. In terms of each ton of the copper oxide ore, 730 g of the composite regulator and 130 g of the composite collector were added for conducting the cleaner-scavenger.

(8) The copper concentrate I obtained in step (6) was combined with the copper concentrate II obtained in step (7) to obtain a copper concentrate. The scavenger tailing obtained in step (4) was taken as a copper tailing.

In this example, a copper recovery of the flotation was 84.2%.

### Example 3

In this example, taking a mass fraction of the composite grinding aid as 100%, the triethanolamine accounted for 60%, the diethylene glycol accounted for 30%, and the polyether amine accounted for 10%. Taking a mass fraction of the composite regulator as 100%, the sodium sulfide accounted for 55%, the ammonium phosphate accounted for 20%, the carboxymethyl cellulose accounted for 10%, and the phosphino-carboxylic acid copolymer accounted for 15%. Taking a mass fraction of the composite collector as 100%, the sodium isoamyl xanthate accounted for 60%, the sodium O,O-diisopropyl dithiophosphate accounted for 30%, and the octyl hydroxamic acid accounted for 10%.

As shown in the Figure, a flotation method for full-particle size recovery of a copper oxide ore was conducted by the following steps:

(1) The copper oxide ore was mixed with the composite grinding aid evenly, and a resulting mixture was added to a grinding mill and ground until copper oxide mineral grains are dissociated. Water was added thereto and conditioned until a mass percentage concentration of an obtained pulp reaches 38% to obtain a copper oxide ore pulp. In terms of each ton of the copper oxide ore, 540 g of the composite grinding aid was added in the grinding mill. A mass percentage content of copper in the copper oxide ore was 1.9%.

(2) The composite regulator, the composite collector, and the frother were added sequentially to the copper oxide ore pulp obtained in step (1). A primary rougher was conducted to obtain a primary rougher concentrate and a primary rougher tailing. In terms of each ton of the copper oxide ore, 2,600 g of the composite regulator, 840 g of the composite collector, and 80 g of the frother were added for conducting the primary rougher.

(3) The composite regulator, the composite collector, and the frother were added sequentially to the primary rougher tailing obtained in step (2), and a secondary rougher was conducted to obtain a secondary rougher concentrate and a secondary rougher tailing. In terms of each ton of the copper oxide ore, 1,300 g of the composite regulator, 420 g of the composite collector, and 40 g of the frother were added for conducting the secondary rougher.

(4) The composite regulator, the composite collector, and the frother were added sequentially to the secondary rougher tailing obtained in step (3), and scavenger was conducted to obtain a scavenger concentrate and a scavenger tailing. In terms of each ton of the copper oxide ore, 650 g of the composite regulator, 210 g of the composite collector, and 20 g of the frother were added for conducting the scavenger.

(5) The primary rougher concentrate obtained in step (2) was combined with the secondary rougher concentrate obtained in step (3), and the composite regulator and the composite collector were added thereto. A primary cleaner was conducted to obtain a primary cleaner concentrate and a primary cleaner tailing. In terms of each ton of the copper oxide ore, 325 g of the composite regulator and 105 g of the composite collector were added for conducting the primary cleaner.

(6) The primary cleaner concentrate obtained in step (5) was subjected to a secondary cleaner to obtain a copper concentrate I and a secondary cleaner tailing.

(7) The scavenger concentrate obtained in step (4), the primary cleaner tailing obtained in step (5), and the secondary cleaner tailing obtained in step (6) were combined to obtain a mixed middling. The composite regulator and the composite collector were added sequentially to the mixed middling, and cleaner-scavenger was conducted to produce a copper concentrate II and a cleaner scavenger tailing. The cleaner-scavenger tailing was returned to the scavenger. In terms of each ton of the copper oxide ore, 860 g of the composite regulator and 160 g of the composite collector were added for conducting the cleaner-scavenger.

(8) The copper concentrate I obtained in step (6) was combined with the copper concentrate II obtained in step (7) to obtain a copper concentrate. The scavenger tailing obtained in step (4) was taken as a copper tailing.

In this example, a copper recovery of the flotation was 86.3%.

The specific embodiments of the present disclosure have been described in detail above, but the present disclosure is not limited to the above embodiments. Various changes can be made without departing from the purpose of the present disclosure within the range of knowledge possessed by those of ordinary skill in the art.

What is claimed is:

1. A flotation method for recovery of copper oxide ore with full-size fractions, comprising following steps:
(1) mixing the copper oxide ore with a composite grinding aid evenly, subjecting a resulting mixture to grinding until copper oxide mineral grains are dissociated, adding water, and conditioning until a mass percentage concentration of an obtained pulp reaches 28% to 38%, to obtain a copper oxide ore pulp;
(2) adding a composite regulator, a composite collector, and a frother sequentially to the copper oxide ore pulp obtained in step (1), and conducting a primary rougher to obtain a primary rougher concentrate and a primary rougher tailing;
(3) adding the composite regulator, the composite collector, and the frother sequentially to the primary rougher tailing obtained in step (2), and conducting a secondary rougher to obtain a secondary rougher concentrate and a secondary rougher tailing;
(4) adding the composite regulator, the composite collector, and the frother sequentially to the secondary rougher tailing obtained in step (3), and conducting scavenger to obtain a scavenger concentrate and a scavenger tailing;
(5) combining the primary rougher concentrate obtained in step (2) with the secondary rougher concentrate obtained in step (3) to obtain a mixture, adding the composite regulator and the composite collector to the mixture, and conducting a primary cleaner to obtain a primary cleaner concentrate and a primary cleaner tailing;
(6) conducting a secondary cleaner on the primary cleaner concentrate obtained in step (5) to produce a copper concentrate I and a secondary cleaner tailing;
(7) combining the scavenger concentrate obtained in step (4), the primary cleaner tailing obtained in step (5), and the secondary cleaner tailing obtained in step (6) to obtain a mixed middling; and adding the composite regulator and the composite collector sequentially to the mixed middling, and conducting cleaner-scavenger to obtain a copper concentrate II and a cleaner-scavenger tailing, wherein the cleaner-scavenger tailing is returned to the scavenger; and
(8) combining the copper concentrate I obtained in step (6) with the copper concentrate II obtained in step (7) to obtain a copper concentrate, and taking the scavenger tailing obtained in step (4) as a copper tailing,
wherein the composite grinding aid is a mixture of triethanolamine, diethylene glycol, and polyether amine; the composite regulator is a mixture of sodium sulfide, ammonium phosphate, carboxymethyl cellulose, and a phosphino-carboxylic acid copolymer; and the composite collector is a mixture of sodium isoamyl xanthate, sodium O,O-diisopropyl dithiophosphate, and octyl hydroxamic acid.

2. The flotation method for recovery of copper oxide ore with full-size fractions of claim 1, wherein in step (1), a mass percentage content of copper in the copper oxide ore is in a range of 0.7% to 1.9%.

3. The flotation method for recovery of copper oxide ore with full-size fractions of claim 1, wherein in terms of each ton of the copper oxide ore, 260 g to 540 g of the composite grinding aid is added in step (1).

4. The flotation method for recovery of copper oxide ore with full-size fractions of claim 1, wherein in terms of each ton of the copper oxide ore, 1,800 g to 2,600 g of the composite regulator, 520 g to 840 g of the composite collector, and 40 g to 80 g of the frother are added for conducting the primary rougher in step (2).

5. The flotation method for recovery of copper oxide ore with full-size fractions of claim 1, wherein in terms of each ton of the copper oxide ore, 900 g to 1,300 g of the composite regulator, 260 g to 420 g of the composite collector, and 20 g to 40 g of the frother are added for conducting the secondary rougher in step (3).

6. The flotation method for recovery of copper oxide ore with full-size fractions of claim 1, wherein in terms of each ton of the copper oxide ore, 450 g to 650 g of the composite regulator, 130 g to 210 g of the composite collector, and 10 g to 20 g of the frother are added for conducting the scavenger in step (4).

7. The flotation method for recovery of copper oxide ore with full-size fractions of claim 1, wherein in terms of each ton of the copper oxide ore, 225 g to 325 g of the composite regulator and 65 g to 105 g of the composite collector are added for conducting the primary cleaner in step (5).

8. The flotation method for recovery of copper oxide ore with full-size fractions of claim 1, wherein in terms of each ton of the copper oxide ore, 600 g to 860 g of the composite regulator and 100 g to 160 g of the composite collector are added for conducting the cleaner-scavenger in step (7).

9. The flotation method for recovery of copper oxide ore with full-size fractions of claim 1, wherein
taking a mass fraction of the composite grinding aid as 100%, the triethanolamine accounts for 50% to 60%, the diethylene glycol accounts for 30% to 40%, and the polyether amine accounts for 5% to 15%;
taking a mass fraction of the composite regulator as 100%, the sodium sulfide accounts for 45% to 55%, the ammonium phosphate accounts for 20% to 30%, the carboxymethyl cellulose accounts for 10% to 20%, and the phosphino-carboxylic acid copolymer accounts for 5% to 15%; and
taking a mass fraction of the composite collector as 100%, the sodium isoamyl xanthate accounts for 40% to 60%, the sodium O,O-diisopropyl dithiophosphate accounts for 20% to 40%, and the octyl hydroxamic acid accounts for 10% to 30%.

10. The flotation method for full-particle size recovery of the copper oxide ore of claim 1, wherein the frother is terpenic oil.
